(19) United States
(12) Patent Application Publication
(10) Pub. No.: US 2009/0133584 A1
(43) Pub. Date: May 28, 2009

(54) EXCHANGEABLE HOLDER FOR USE IN AN APPARATUS FOR PREPARING A BEVERAGE SUITABLE FOR CONSUMPTION

(75) Inventors: Gerbrand Kristiaan De Graaff, Lisse (NL); Hendrik Cornelis Koeling, Amersfoort (NL); Ka Cheung Tsang, Amsterdam (NL); Ralf Kamerbeek, Utrecht (NL)

Correspondence Address: FOLEY & LARDNER LLP, 777 EAST WISCONSIN AVENUE, MILWAUKEE, WI, 53202-5306, US

(73) Assignee: Sara Lee/De N.V.

(21) Appl. No.: 12/297,619

(22) PCT Filed: Apr. 19, 2007
(86) PCT No.: PCT/NL07/50163

§ 371 Date: Jan. 14, 2009

(30) Foreign Application Priority Data
Apr. 19, 2006 (NL) 1031622
Jun. 29, 2006 (NL) 1032080

(51) Int. Cl. A47J 31/44

(52) U.S. Cl. 99/279

(57) ABSTRACT

A system (1) for preparing a predetermined amount of beverage suitable for consumption, provided with an exchangeable holder (2) and an apparatus (4) provided with a fluid dispensing device (6) which is detachably connected to the holder (2) for dispensing at least an amount of at least a base fluid such as water under pressure to the exchangeable holder (2), wherein the exchangeable holder (2) is provided with at least a first (8′) and a second storage space (8″) which are filled with a first and second fluid, respectively, and a mixing chamber (10) for mixing the base fluid and the first and/or second fluid therein, while the mixing chamber (10) is situated at a position between the first storage space (8′) and the second storage space (8″).

The invention relates to an exchangeable holder for use in an apparatus provided with a fluid dispensing device for dispensing at least one base fluid, in particular water, under pressure to the holder for preparing a beverage suitable for consumption. Such a holder is described in NL1031622 and is provided with a storage space filled with a concentrate.

The holder described in NL1031622 is provided with, for instance, a mixing chamber and a storage space with a wall, while the storage space is filled with a coffee concentrate. The holder is further provided with a fluid communication between the storage space and the mixing chamber. Further, the mixing chamber is connected to an inlet which, in use, is detachably connected to an outlet of the water dispensing device. In use, also, a needle of the fluid dispensing device is pierced through the wall of the storage space. In this configuration, a pressure is then applied in the storage space to the coffee concentrate, whereby this flows through the fluid communication to the mixing chamber. Simultaneously, the water dispensing device dispenses water under pressure to the holder. Via the inlet, the water ends up in the mixing chamber together with the coffee concentrate, where coffee is formed from the coffee concentrate and the water. Then, the coffee leaves the holder via an outflow opening and is captured in a mug, whereupon the coffee is ready for consumption.

For preparing many a beverage, it is desirable that upon preparation, more than one ingredient is processed separately. It is, therefore, desirable to keep the ingredients separate prior to the preparation of the beverage. This can be realized by providing the holder with at least two storage spaces. An example of a beverage with which this can be desirable is cappuccino. If the beverage is cappuccino, the one storage space can be provided with coffee concentrate and the other storage space with milk concentrate.

A drawback of the above-mentioned holder is that the holder can have a considerable size when the holder is provided with several storage spaces.

An object of the invention is to offer the possibility to obviate the above-mentioned drawback at least partially.

This object is achieved with the aid of the invention, with which the exchangeable holder is provided with at least a first and a second storage space which are filled with a first fluid and a second fluid, respectively, for instance a coffee concentrate as first fluid and a milk concentrate as second fluid, the exchangeable holder being provided with at least one mixing chamber, at least one outflow opening which is in fluid communication with the mixing chamber for dispensing the beverage from the mixing chamber, and at least one inlet opening for allowing the base fluid to enter from the fluid dispensing device, and for supplying the base fluid to the mixing chamber, the holder further being provided with at least a first fluid communication for dispensing the first fluid from the storage space to the mixing chamber and with at least a second fluid communication for dispensing the second fluid from the second storage space to the mixing chamber, while the mixing chamber is situated at a position between the first storage space and the second storage space.

As the mixing chamber is situated at a position between the storage spaces, an efficient manner of design of the holder is possible, which offers the possibility of limiting the dimensions of the holder. It has as a further advantage that manufacture of the holder requires less material, which saves costs and spares the environment.

One embodiment of the holder according to the invention is particularly preferred, in which, at a first location of the first storage space, the first storage space is or can be brought in fluid communication with the first fluid communication, and, at a second location of the second storage space, the second storage space is or can be brought in fluid communication with the second fluid communication, the holder being designed such that in at least a predetermined position, the first and the second location are positioned downwards from the first storage space and the second storage space, respectively. Such a configuration can be utilized for presenting the possibility that, in use, fluid contacts between storage spaces and fluid communications are located as far downward as possible which helps the storage spaces empty completely. The fact is that, if, in the at least one position, for instance a position of use in which the holder is utilized, the first location is located downwards from the first storage space and the second location is downwards from the second storage space, at the first and second location, each time above the first location or above the second location, respectively, a portion of the first or second fluid, respectively, will be present until the storage spaces are empty. For dosed supply of the first fluid from the first storage space to the mixing chamber, in use, the first fluid is pressurized. Also, for dosed supply of the second fluid from the second storage space to the mixing chamber, the second fluid is pressurized. As the first location is located at the underside of the first storage space, the first fluid will leave the first storage space via a low point of the first storage space, so that a pressure applied to the first fluid in the first storage space, for instance due to the supply under pressure of a third fluid to the first storage space, can be maintained until at least virtually all the first fluid has disappeared from the first storage space. This applies, mutatis mutandis, also for the second fluid present in the second storage space. In both cases, by means of the pressure of the third fluid, which is supplied to the first and the second storage space, respectively, a pressure can be applied to the first and second fluid, respectively, for dispensing the first fluid in a dosed manner to the mixing chamber and dispensing the second fluid in a dosed manner to the mixing chamber. If, for instance, with the first storage space, the first location mentioned were present at a height halfway the first storage space, it would not be possible to press, in this manner, at least the larger part of the first fluid from the first storage space. This applies mutatis mutandis also for the second fluid present in the second storage space. Therefore, the pressure which presses the first fluid and the second fluid from the storage space during dispensing of the first fluid and the second fluid to the mixing chamber, continues to press the first fluid from the first storage space and the second fluid from the second storage space until the first storage space contains at least virtually no further first fluid and the second storage space contains virtually no further second fluid.

Although, in this configuration, placing the mixing chamber adjacent the same sides of respective storage spaces at which sides the first and second location are situated, would considerably limit the dimension of the respective fluid communications, it is still preferred, for the above-mentioned reasons, that the mixing chamber is located between the storage spaces. Herein, dimension is understood to mean a length of the first fluid communication and a length of the second fluid communication.

Further, an embodiment of the holder according to the invention is advantageous, with which the holder is of substantially symmetrical design. This is favourable in particular if the holder is mirror symmetrical with respect to a plane of symmetry that intersects the mixing chamber substantially in a longitudinal direction. Preferably, it applies here that the plane of symmetry is perpendicular to a plane in which are located the first storage space, the second storage space and the mixing chamber. Such symmetry can entail that the fluid communications have substantially the same length, which has as an advantage that the apparatus for dispensing the first and the second fluid can employ the same pressure, flow rate, starting time and end time, which simplifies control of the apparatus considerably.

Presently, the invention will be further elucidated with reference to the drawing.

In the drawing:

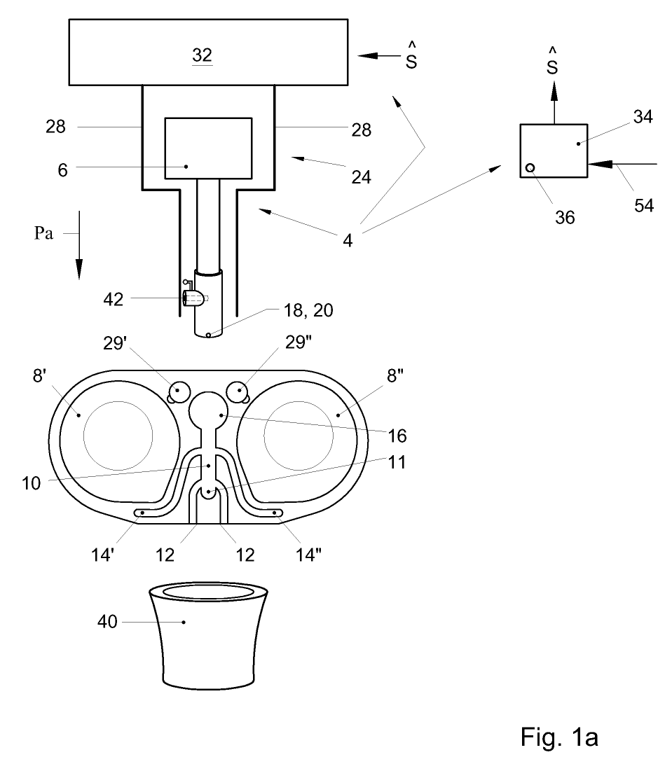

FIG. 1 shows a first embodiment of a system according to the invention provided with a holder according to the invention;

FIG. 1b shows the system according to FIG. 1a in operative condition;

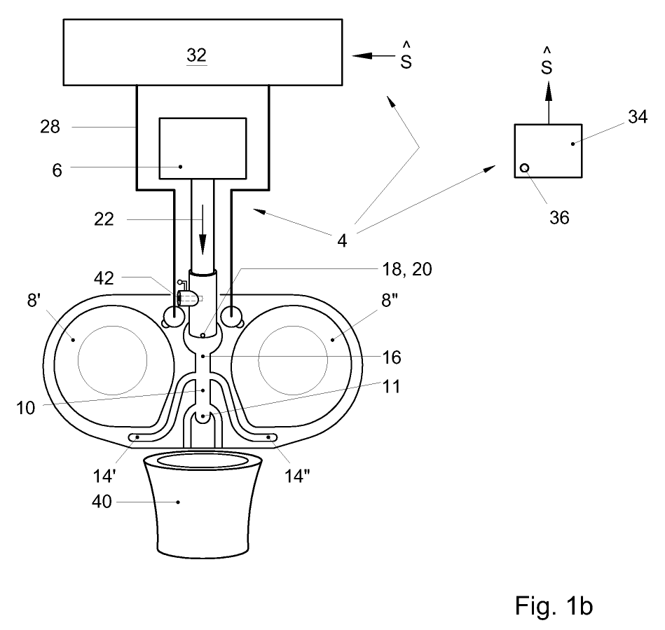

FIG. 2 shows, in further detail, the holder of FIG. 1a;

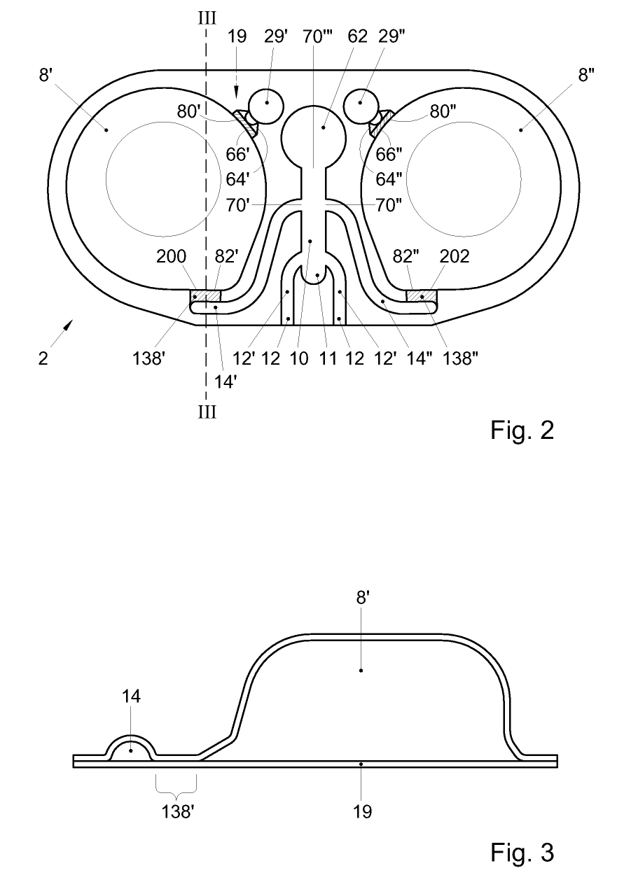

FIG. 3 shows a cross-section, in a plane III shown in FIG. 2, of the holder of FIG. 1a.

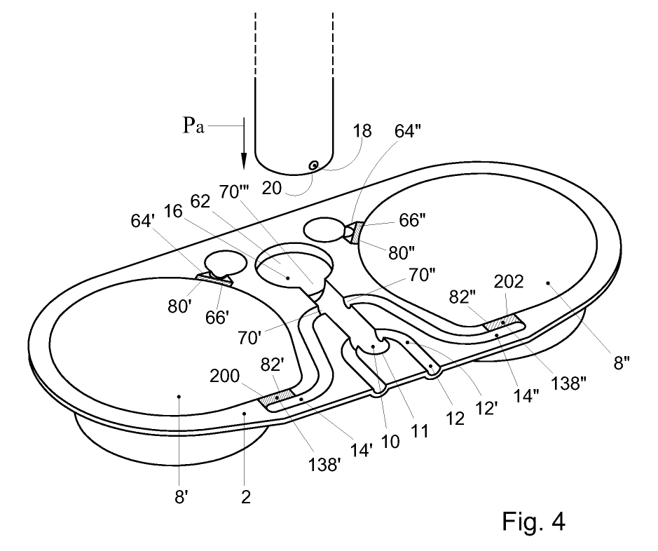

FIG. 4 shows, in perspective view, a part of the system according to FIG. 1a.

In FIG. 1, reference numeral 1 indicates a system for preparing a predetermined amount of beverage suitable for consumption. The system (see FIG. 1a) is provided with an exchangeable holder 2 and an apparatus 4 which is provided with, inter alia, a fluid dispensing device 6 designed for dispensing, under pressure, at least a base fluid such as a liquid and/or a gas, more particularly such as water and/or steam. In this example, in use, the fluid dispensing device 6 dispenses water.

In this embodiment, the exchangeable holder 2 is provided with a first storage space 8′ which is filled with a first fluid and a second storage space 8″ which is filled with a second fluid. The first and the second fluid can for instance be a beverage, a concentrate or a powder. An example is that the first fluid is coffee concentrate and the second fluid is a milk concentrate. In this example, the storage spaces 8 are formed by rigid walls. However, this is not required. In this embodiment, the holder 2 is further provided with at least one mixing chamber 10 and two outflow openings 12 which are in fluid communication with the mixing chamber 10. The mixing chamber 10 is situated at a position between the storage spaces 8, as is clearly visible in FIGS. 1a, 1b and 2. In this embodiment of the holder, the holder 2 is further provided with a first fluid communication 14′ between the first storage space 8′ and the mixing chamber 10 and a second fluid communication 14′ between the second storage space 8″ and the mixing chamber 10. Both fluid communications 14′, 14′ are of S-shaped design. The holder 2 is further provided with at least one inlet opening 16 which is be detachably connectable to an outlet opening 18 of the fluid dispensing device 6. In FIG. 1a, the inlet opening 16 is not yet connected to the outlet opening 18. This is, however, the case in FIG. 1b. In this example, the inlet opening 16 in FIG. 1a is still sealed off.

For a further description of the holder 2, reference is made now to FIGS. 2 and 3. In this example, the holder 2 according to the invention comprises a blister pack. The blister pack is provided with blister chambers and a covering 19 of the blister chambers. FIG. 2 is a top plan view to the side of the blister pack where the material of which the blister chambers have been deep-drawn is situated. On the opposite side is situated the covering 19 of the blister chambers. In this embodiment, the storage spaces 8′, 8″, the mixing chamber 10 and the fluid communications 14 are each formed by one of the blister chambers. In this example, the mixing chamber 10 is connected to two outflow openings 12 via two outflow channels 12′ formed by further blister chambers of the blister pack 2.

The blister pack 2 is further provided with fluid communication seals 138′ for bringing the fluid communications 14′ into operation through removal of the sealing action of the fluid communication seals 138′. The blister pack is further provided with a fluid communication seal 138″ for bringing the second fluid communication 14″ into operation through removal of the sealing action of the fluid communication seal 138″. In the example shown, the fluid communication seals 138 are each a peel seal 38, which are weakened parts with respect to the sealing attachment between, on the one side, material of which the blister chambers have been deep-drawn and, on the other side, material of the covering of the blister chambers. Once the sealing action of the fluid communication seals 138′ has been removed, in that the first fluid in the first storage space is sufficiently pressurized so that the seal 138′ opens, the first storage space 8′ enters into fluid communication with the first one fluid communication 14′ at a first location 200, in this example at an underside of the storage space 8′. Also, the second storage space 8″ enters into fluid communication with the second fluid communication 14′ at a second location 202, in this example at an underside of the storage space 8″ when the sealing action of the seal 138″ is removed in that the second fluid is sufficiently pressurized in the second storage space. Therefore, in this example, the holder 2 is designed such that in the position of use shown, the first location is positioned downwards from the first storage space, and the second location is positioned downwards from the second storage space. More generally, it applies that the holder is designed such that in at least a predetermined position, the first and the second location are positioned downwards from the first storage space and the second storage space, respectively. As, in this manner, the first storage space and the second storage space both have the location where the first fluid flows from the first storage space and the second fluid flows from the second storage space on the same side, the holder 2 can be positioned in the at least one position so that this location is situated at the underside of the storage spaces 8′, 8″.

Referring, once more, to FIGS. 1a and 1b, in this example, the system is further provided with a restriction 20 included in a fluid flow path which extends, via the outlet opening 18 of the fluid dispensing device 6, the inlet opening 16 and the mixing chamber 10, from the fluid dispensing device 6 to the outflow opening 12.

More particularly, it applies in this example that the restriction 20 is included in a fluid flow path 22 which extends, via the outlet opening 18 of the fluid dispensing device 6 and the inlet opening 16 of the exchangeable holder 2, from the fluid dispensing device 6 to the mixing chamber 10. In this example, the restriction 20 forms the outflow opening 20. With the aid of the restriction, a jet of the base fluid can be formed with which, in the situation as shown in FIG. 1, it is possible to spout into the mixing chamber.

The storage spaces 8′ and 8″ form at least a part of a dosing device 24 as will be further set forth hereinafter. In this example, this dosing device 24 is further provided with two needles 28 which, in use, are pierced through walls of the fluid inlets 29′ and 29″. Here, the fluid inlets are designed as blister chambers 29′ and 29″. In use, the blister chambers 29′ and 29″ enter into fluid contact with the respective storage spaces 8 for supplying a third fluid to the first and second fluid in the storage spaces 8′, 8″, for dispensing the first and second fluid in a dosed manner to the mixing chamber 10. In this example, the dosing device 24 is further provided with a fluid dispensing unit 32 which is connected to the needles 28. The fluid dispensing unit 32 and the needles 28 form part of the apparatus 4. The fluid dispensing unit 32 is, in this example at least via the needles 28, detachably connectable to the holder 2.

The apparatus 4 is further provided with a control device 34 for controlling the fluid dispensing device 6 and the fluid dispensing unit 32. To control the fluid dispensing device 6 and the fluid dispensing unit 32, the control device 34 generates control signals ŝ which are supplied to the fluid dispensing device 6 and the fluid dispensing unit 32. In this example, the control device 34 is designed for controlling the fluid dispensing device 6 and the fluid dispensing unit 32 independently of each other.

The system 1 described heretofore works as follows. For the purpose of preparing a predetermined amount of beverage suitable for consumption, the exchangeable holder 2 is placed in the apparatus 4. Here, the fluid inlets, in this example designed as the blister chambers 29 of the exchangeable holder 2, are placed under the needles 28. Also, as shown in FIG. 1b, the outlet opening 18 is connected to the inlet opening 16. A tube 60 of the fluid dispensing unit is pressed through a wall of the blister pack so that this reaches into a blister chamber 62. Then, via the outlet opening 18, a jet of the base fluid can be generated which spouts into the mixing chamber 10 as will be described hereinafter. The apparatus is now ready for use. By, for instance, pushing a button 36 of the control device 34, the control device ensures that the fluid dispensing unit 32 starts moving the needles 28 in the direction of the arrow Pa. The result hereof is that the needles 28 are pierced through the walls of the blister chambers 29 and that the third fluid is supplied under pressure to the first fluid and the second fluid in the storage spaces 8′ and 8″. As a result, the third fluid will apply a pressure and/or force to the first fluid and the second fluid. Consequently, in this example, the pressure in the storage spaces 8′, 8″ will increase. As a result, the seals 138′, 138″ will open. As a result, in this example, the coffee concentrate will flow in a dosed manner from the storage space 8′, 8″, via the fluid communication 14, to the mixing chamber 10. Simultaneously, the control 34 effects that the fluid dispensing device 6 is activated. This results in that the fluid dispensing device 6 starts dispensing, under pressure, the base fluid, in this example water. In this example, this water is hot water with a temperature of, for instance 80-98° C. This hot water flows, via the fluid flow path 22, to the restriction 20. Having arrived at the restriction 20, a jet is generated of the hot water by means of the restriction 20. This jet spouts via the outlet opening 18 and the inlet opening 16 into the first mixing chamber 10. In the mixing chamber 10, the hot water will start mixing well with the concentrate. Here, the flow rates at which the first and second fluids are supplied to the mixing chamber 10 are regulated by the control device 34 through control of the fluid dispensing unit 32. Further, the flow rate at which the hot water is supplied to the mixing chamber 10 is also regulated by the control device 34 through control of the fluid dispensing device 6. As a result of the jet, in the mixing chamber 10, the first and second fluid will mix well with the hot water so that the beverage is formed. This beverage can then leave the outflow opening 12 and be captured in, for instance, a mug 40.

As, with the system 1 according to the invention, both the dosing of the first and the dosing of the second fluid over time can be regulated well while, furthermore, the dosing of the hot water over time can be regulated well, it can be ensured that the concentration of the amount of first and second fluid in the beverage can be accurately determined. Furthermore, it can be ensured that the beverage which, during its preparation, leaves the outflow opening 12, is of constant quality, i.e., the concentration of the first and second fluid in the beverage that is dispensed can be kept substantially constant during dispensing, if desired. The fact is that in this example, the flow rate of the water and the flow rate of the first and second fluid supplied to the first mixing chamber 10 can each, if desired, be controlled independently of each other. It therefore applies in this example, that the system 1 is designed in a manner such that the fluid dispensing device 6 and the dosing device 24 can supply the base fluid and the first and second fluid to the first mixing chamber 10, independently of each other. This entails that the size of the flow rate of the base fluid and the period during which the base fluid is dispensed are independent (in this example through control of the control device) of the size of the flow rate of the first fluid and the period during which the first fluid is dispensed, and are independent of the size of the flow rate of the second fluid and the period during which the second period is dispensed.

If, for instance, cappuccino is prepared, the first storage space 8′ can for instance contain coffee concentrate and a second storage space 8″ can contain milk concentrate. In that case, the control device 34 can effect that, first, the fluid dispensing unit 32 supplies the third fluid under pressure to the coffee concentrate, so that first, the coffee concentrate is supplied to the mixing chamber. Then, for instance after a predetermined time interval, the control device 34 effects that the fluid dispensing unit 32 supplies the third fluid under pressure to the milk concentrate so that then, instead of or in addition to the coffee concentrate, the milk concentrate is supplied to the mixing chamber 10. It further applies in this example, that the dosing device 24 is a controllable and active dosing device for supplying the first fluid to the mixing chamber 10 through the application of an increased pressure or force to the first fluid. Herein, an active dosing device is understood to mean that the first fluid and/or the second fluid flows through the fluid communication from the storage spaces to the mixing chamber as a result of an excess pressure or force applied on the side of the storage space.

In the example, the system 1 is further provided with an air inlet opening 42. The air inlet opening 42 ensures the supply of air to the first mixing chamber 10 so that, in use, air is whipped into the beverage for obtaining a beverage with a fine-bubble froth layer. Thus, a café crème can be obtained. In this example, the air inlet opening 42 is in fluid communication with the first mixing chamber 10 downstream of the restriction 20. In this example, the air inlet opening 42 terminates, via a fluid communication 44, into the fluid flow path 22. In this example it therefore applies, that the air inlet opening and the restriction 20 each form part of the apparatus 4. However, this is not required. It will be clear that the air inlet opening 42 and/or the restriction 20 can form part of the exchangeable holder 2.

After the beverage, in this example coffee with a fine-bubble froth layer, has been prepared, the control device 34 stops the fluid dispensing device 6. The control device 34 also ensures that the third fluid is no longer supplied to the first fluid and/or the second fluid in the storage spaces, and that the needles 28 are retracted from the respective wall of the storage spaces 8′, 8″, i.e., in a direction opposite that of the arrow Pa. Here, it may be such that the control device 34 first provides that the dispensing of the first fluid and/or the second fluid to the mixing chamber is stopped and that after that, the supply of the base fluid (in this example, water) is stopped. Thus, the risk of the first fluid and/or the second fluid contaminating, for instance, the restriction 20 is reduced.

FIG. 1b shows a situation where the needles 28 are pierced through walls of the blister chambers 29 and via which blister chambers 29 the third fluid is supplied under pressure to the first and second fluid in the storage space 8′, 8″. The situation shown occurs at the moment when the control device 34 will stop the supply of hot water to the first mixing chamber 10, will no longer effect the supply of the third fluid to the first and the second fluid in the storage spaces 8′, 8″, and will effect the retraction of the needles 28 from the respective walls of the storage spaces 8′, 8″ so that, thereupon, the holder 2 can be taken from the apparatus 4 again.

After this, a user can remove the exchangeable holder 2 and, if a new amount of beverage is to be prepared, place a new exchangeable holder 2 in the apparatus 4. The new exchangeable holder can be provided with an entirely different type of first and/or second fluid such as, for instance, a tea concentrate. When, with the aid of the new exchangeable holder, tea is prepared in a manner comparable to that as described for the preparation of coffee based on coffee concentrate, in the prepared tea, no trace will be found of the previously prepared type of beverage. The fact is that the mixing chamber 10 forms part of the exchangeable holder and when a new exchangeable holder is placed in the apparatus 4, also, an entirely new and, hence, clean mixing chamber is placed in the holder. Therefore, contamination cannot be involved.

In the example of FIGS. 1a-1b, the dosing device 24 is designed for supplying the third fluid under pressure to the first fluid and the second fluid in the storage spaces 8′, 8″ for dispensing these fluids in a dosed manner to the mixing chamber 10. It will be clear that in addition or as an alternative, the dosing device 24 can be provided with a compressing unit for compressing the storage spaces 8′, 8″ for dispensing the first fluid and/or the second fluid in a dosed manner to the mixing chamber 10 as described in, for instance, WO 2006/04380.

In the example of FIGS. 1a-1b, the jet of the base fluid spouts into the first mixing chamber 10. It is possible that here, the jet impacts on an inside wall of the mixing chamber 10, while swirls are formed in the mixing chamber 10, resulting in that the first and second fluid, the base fluid and, optionally, air, are mixed together. It is also possible that the jet impacts on a jet impact element in the mixing chamber 10. Upon impact of the jet on the jet impact element, the liquid is atomized, so that air can be whipped in well.

In the examples of FIGS. 1a, 1b and 2, the holder is of substantially symmetrical design. In the examples, the holder is mirror symmetrical with respect to a plane of symmetry which intersects the mixing chamber substantially in a longitudinal direction, in the examples parallel to a direction in which the jet is supplied to the mixing chamber. In the examples, the plane of symmetry is further transverse to a plane in which the covering extends, i.e. the plane of symmetry is perpendicular to a plane in which are located the first storage space, the second storage space and the mixing chamber. Such symmetry can entail that the fluid communications have substantially equal lengths, which has as an advantage that the apparatus can have the fluid dispensing unit for dispensing the first and the second fluid employ the same pressure, flow rate, starting time and end time, which simplifies control of the apparatus considerably.

It will be clear to the skilled person that the invention is not limited to the embodiment mentioned hereinabove. In this example, between the first fluid inlet 29′ and the first storage space extends a third fluid communication 64′, while in the third fluid communication, a fluid communication seal 66′ is included. Through removal of the fluid communication seal of third fluid communication 64′, the third fluid communication can be brought into operation. The seal 66 can, once more, be designed as, for instance, a peel seal that opens when the third fluid is supplied to the first fluid inlet 29′ at sufficient pressure. Completely analogously, the holder is provided with a fourth fluid communication 64″ which extends from the second fluid inlet 29″ to the second storage space 8″. In the fourth fluid communication, a fluid communication seal 60″ is included of the same sort as described in relation to the fluid communication seal 60′. The fluid communication seal 60″ can be opened in the same manner as described for the fluid communication seal 60′.

Here, it further applies that the fluid communication seal 66′ is located at least near a top side of the first storage space. It also applies that the fluid communication seal 66′ is located at least near a top of the second storage space.

It also applies that the first mixing chamber comprises a first entrance opening 70′, a second entrance opening 70′ and a third entrance opening 70′″. These entrance openings are separated at a distance from each other. In use, the first fluid flows into the mixing chamber via the first entrance opening, the second fluid flows into the mixing chamber via the second entrance opening and the base fluid enters the mixing chamber via the third entrance opening. The first fluid communication terminates into the first entrance opening and the second fluid communication terminates into the second entrance opening. Further, the at least one inlet opening 16 is in fluid communication with the third entrance opening. In the examples, it further applies that the first storage space in the position mentioned is provided, near its top, with a supply opening 80′ for supplying the third fluid, under pressure, to the first storage space, and is provided at its bottom with a discharge opening 82′ for supplying the first fluid from the first storage space 4 via the first fluid communication to the mixing chamber. It also applies that the second storage space, in the operative position is provided near its top with a supply opening 80″ for supplying a third fluid, under pressure, to the second storage space, and is provided at its bottom with a discharge opening 82″ for supplying the second fluid from the second storage space via the second fluid communication to the mixing chamber. More in general, the supply opening 80′ is located, in the position, above half an inside height of the first storage space. It also applies, more in particular, that the supply opening 80″ is located, in the position, above half an inside height of the second storage space. For instance, more than two storage spaces can be provided and/or more than one mixing chamber. Further, the blister chambers may have been deep-drawn, as mentioned hereinabove, but it is also possible to manufacture the blister packs by means of, for instance, vacuum formation, thermoformation, pressing and/or deep pressing. The skilled person will further understand that it is possible to use similar fluids as first and second fluids without deviating from the invention as set forth in the accompanying claims. It is, for instance, possible that both the first fluid and the second fluid are tea concentrates or that both the first fluid and the second fluid are coffee concentrates.

1. An exchangeable holder for use in an apparatus provided with a fluid dispensing device for dispensing at least a base fluid such as a gas and/or liquid, in particular water or steam, under pressure to the holder for preparing a beverage suitable for consumption, the exchangeable holder comprises:
at least a first and a second storage space which are filled with a first fluid and a second fluid, respectively, for instance a coffee concentrate as first fluid and a milk concentrate as second fluid,
at least one mixing chamber,
at least one outflow opening which is in fluid communication with the mixing chamber for dispensing the beverage from the mixing chamber,
at least one inlet opening for allowing the base fluid to enter from the fluid dispensing device, and for supplying the base fluid to the mixing chamber,
at least a first fluid communication for dispensing the first fluid from the first mixing chamber to the mixing chamber, and
at least a second fluid communication for dispensing the second fluid from the second storage space to the mixing chamber, while the mixing chamber is situated at a position between the first storage space and the second storage space.

2. A holder according to claim 1, wherein, at a first location of the first storage space, the first storage space is or can be brought in fluid communication with the first fluid communication, and, at a second location of the second storage space, the second storage space is or can be brought in fluid communication with the second fluid communication, the holder being designed such that in at least a predetermined position, the first and the second location are positioned downward from the first storage space and the second storage space, respectively.

3. A holder according to claim 1, wherein the first storage space and the second storage space are storage space separated from each other.

4. A holder according to claim 1, wherein, in use, the first storage space and the second storage space within the holder can be in fluid communication with each other exclusively via the first fluid communication, the second fluid communication and the mixing chamber.

5. A holder according to claim 1, wherein the holder is of substantially symmetrical design.

6. A holder according to claim 3, wherein the holder is mirror symmetrical with respect to a plane of symmetry which intersects the mixing chamber substantially in a longitudinal direction.

7. A holder according to claim 6, wherein the plane of symmetry is perpendicular to a plane in which are located the first storage space, the second storage space and the mixing chamber.

8. A holder according to claim 1, wherein the first fluid communication is provided with a fluid communication seal for bringing the first fluid communication into operation through removal of the sealing action of the fluid communication seal of the first fluid communication and/or wherein the second fluid communication is provided with a fluid communication seal for bringing the second fluid communication into operation through removal of the sealing action of the fluid communication seal of the second fluid communication.

9. A holder according to claim 8, wherein, at a first location of the first storage space the first storage space can be brought in fluid communication with the first fluid communication, and, at a second location of the second storage space the second storage space can be brought in fluid communication with the second fluid communication, so that in at least a predetermined position the first location and the second location are positioned downward from the first storage space and the second storage space respectively, and wherein the fluid communication seal of the first fluid communication is located at least near an underside of the first storage space and/or wherein the fluid communication seal of the second fluid communication is located at least near an underside of the second storage space.

10. A holder according to claim 1, further comprising at least one fluid inlet and a second fluid communication seal extending from the at least one fluid inlet to at least one of the storage spaces for bringing fluid contact between the fluid inlet and the storage space into operation through removal of the sealing action of the fluid communication seal.

11. A holder according to claim 9, further comprising a first fluid inlet and a third fluid communication extending from the first fluid inlet to the first storage space, while in the third fluid communication a fluid communication seal is included for bringing the third fluid communication into operation through removal of the fluid communication seal of the third fluid communication and/or wherein the holder is provided with a second fluid inlet and a fourth fluid communication extending from the second fluid inlet to the second storage space, while in the fourth fluid communication a fluid communication seal is included for bringing the fourth fluid communication into operation through removal of the fluid communication seal of the fourth fluid communication.

12. A holder according to claim 11, wherein the fluid communication seal of the third fluid communication is located at least nears a top side of the first storage space and/or wherein the fluid communication seal of the fourth fluid communication is located at least near a top side of the second storage space.

13. A holder according to claim 1, wherein the first mixing chamber comprises a first entrance opening, a second entrance opening and a third entrance opening which are at a distance from each other, while, in use, the first fluid enters the mixing chamber via the first entrance opening, the second fluid enters the mixing chamber via the second entrance opening and the base fluid enters the mixing chamber via the third entrance opening.

14. A holder according to claim 13, wherein the first fluid communication terminates into the first entrance opening and the second fluid communication terminates in the second entrance opening.

15. A holder according to claim 13, wherein the at least one inlet opening is in fluid communication with the third entrance opening.

16. A holder according to claim 1, wherein the holder is substantially formed from a blister pack provided with at least one blister chamber and a covering.

17. A holder according to claim 16, wherein at least one of the storage spaces is formed as a blister chamber.

18. A holder according to claim 16, wherein at least the mixing chamber is formed as a blister chamber.

19. A holder according to claim 1, further comprising an air inlet opening for supplying air to the mixing chamber.

20. A holder at according to claim 2, wherein the first storage space is provided in the position at least near its top and above half an inside height of the first storage space with a supply opening for supplying a third fluid under pressure to the first storage space, and is provided at its bottom with a discharge opening for supplying the first fluid from the first storage space via the first fluid communication to the mixing chamber and/or that the second storage space is provided in the position near its top and above half an inside height of the second storage space with a supply opening for supplying a third fluid under pressure to the second storage space, and is provided at its bottom with a discharge opening for supplying the second fluid from the second storage space via the second fluid communication to the mixing chamber.

21. A system for preparing a predetermined amount of beverage suitable for consumption, the system comprising:
an exchangeable holder and
an apparatus having a fluid dispensing device which is detachably connected to the holder for dispensing at least an amount of at least the base fluid, such as a gas and/or liquid, in particular water and/or steam, under pressure, to the exchangeable holder, wherein the inlet opening is detachably connected to an outlet opening of the fluid dispensing device for supplying the base fluid to the mixing chamber,
a dosing device which is designed for supplying, in a dosed manner, the first fluid from the first storage space and the second fluid from the second storage space to the mixing chamber by applying a pressure to the first fluid in the first storage space and to the second fluid in the second storage space,
wherein the fluid dispensing device is designed for supplying the base fluid under pressure to the mixing chamber so that, in the mixing chamber, the base fluid and the first fluid mix together and/or the base fluid and the second fluid mix together for obtaining the beverage which then leaves the exchangeable holder via the outflow opening.

22. A system according to claim 21, wherein the dosing device is designed for supplying a third fluid, such as a gas or a liquid, to the first fluid for applying a pressure, by means of the pressure of the third fluid, to the first fluid for supplying the first fluid via the first fluid communication in a dosed manner to the mixing chamber and/or supplying the third fluid to the second fluid for applying a pressure, by means of the pressure of the third fluid, to the second fluid for supplying the second fluid via the second fluid communication in a dosed manner to the mixing chamber.

23. A system according to claim 22, further comprising a holder having a first fluid inlet and a third fluid communication extending from the first fluid inlet to the first storage space, wherein the third fluid is supplied under pressure to the first fluid inlet for supplying the first fluid in a dosed manner, via the first fluid communication, to the mixing chamber and/or wherein the third fluid is supplied under pressure to the second fluid inlet for supplying the second fluid in a dosed manner via the second fluid communication to the mixing chamber.

24. A system according to claim 21, wherein the dosing device for said dosed supply of the first and/or second fluid from the first and second storage space, respectively, to the first mixing chamber is provided with a compressing unit for compressing the first and/or second storage space.

25. A system according to claim 21, further comprising an air inlet opening for supplying air to the mixing chamber of the holder.
